(19) United States
(12) Patent Application Publication
(10) Pub. No.: US 2010/0030815 A1
(43) Pub. Date: Feb. 4, 2010

(54) IMAGE FILE MANAGEMENT METHOD AND IMAGE FILE MANAGEMENT APPARATUS

(75) Inventor: Nobuo Onuma, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/511,929

(22) Filed: Jul. 29, 2009

(30) Foreign Application Priority Data
Jul. 30, 2008 (JP) 2008-196407

(51) Int. Cl. G06F 17/30

(52) U.S. Cl. 707/200; 707/E17.031

(57) ABSTRACT

A method for managing an image file in which a plurality of images each having ancillary information is sequentially included, and in which a main image among the plurality of images is indicated based on the ancillary information of the image stored at a head of the image file, includes inputting an instruction to delete an image included in the image file, and based on the input of the instruction, deleting images other than at least the main image from among the plurality of images included in the image file based on the ancillary information of the image stored at the head of the image file.

### BACKGROUND OF THE INVENTION

1. Field of the Invention

The present invention relates to a file management method for managing an image file in which a plurality of images each having ancillary information are included in order.

2. Description of the Related Art

Recently, multifunction peripherals (MFP) that have an interface unit which provides a memory card slot for connecting a memory card which stores an image captured by a digital camera or a communication unit with a digital camera and a print unit are in wide spread use. Further, printing has become popular which is performed without a personal computer (PC) by utilizing a photograph printing function of the MFP. In such a case, a user can easily print a desired image just by taking the memory card from the digital camera and inserting it into a printer, or by connecting the digital camera to the MFP with a predetermined interface cable.

However, there are many formats for image files stored in the memory card, and some formats can store a plurality of images in a single file together. Storing a plurality of images in one file allows a user to manage images which are interspersed among a plurality of files in the single file. As an example of such a file, a series of a plurality of images captured using a continuous shooting function of the digital camera is stored in one file. Another example is to capture images while changing the shooting conditions, such as white balance, over several stages in a “+” or “−” manner using a bracketing photographing function of the digital camera, and store a plurality of captured images in one file. In such usage, the images can be stored as one file in association with each other.

However, for such a file, although a plurality of associated images can be managed together, a resultant file size is larger than when the file stores a single image. Thus, a capacity of the memory card tends to quickly run out. More specifically, although a plurality of associated images are stored in one file, in many cases a user does not require all of the images. Rather, the user will often only require one or two images which match his/her intention at the time of capturing images. In such a case, since the remaining images do not match the user's intention, they may be determined as unwanted images.

Therefore, a method is required which allows the user to simply delete the unwanted images from among the plurality of images. For example, Japanese Patent Application Laid-Open No. 2004-201247 discusses a technique for determining images which were captured defectively based on information such as shaking during image-capture, improper exposure, and improper focus, adding the information indicating such defective images thereinto and deleting these images in one batch.

While the above-described technique determines whether an image was captured defectively based on shaking, exposure, and focus, causes of defective image capture are not limited to those. Further, when a plurality of images is stored in one file, defective images and successful images are present in the same file. This gives rise to a problem that the successful images may also be simultaneously deleted.

Moreover, if a user deletes images by checking whether the images in the file were captured successfully or defectively, checking all of the images is a tiresome task for the user.

### SUMMARY OF THE INVENTION

The present invention is directed to an image file management method for deleting an image which is not required by a user from among a plurality of images included in one image file by a simple operation.

According to an aspect of the present invention, a method for managing an image file in which a plurality of images each having ancillary information is sequentially included, and in which a main image among the plurality of images is indicated based on the ancillary information of the image stored at the head of the image file, includes inputting an instruction to delete an image included in the image file, and based on the input of the instruction, deleting images other than at least the main image from among the plurality of images included in the image file based on the ancillary information of the image stored at the head of the image file.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is an external view of a MFP as an image processing apparatus according to an exemplary embodiment of the present invention.

FIG. 2 is a block diagram illustrating a configuration of the MFP in FIG. 1.

FIG. 3 illustrates a plural image format in the exemplary embodiment of the present invention.

FIG. 4A illustrates plural image format ancillary information of an nth image (n being an integer of 2 or more)

FIG. 4B illustrates plural image format ancillary information of a first image.

FIG. 5 illustrates an index IFD of the plural image format.

FIG. 6 illustrates an entry configuration.

FIG. 7 illustrates an internal configuration of image types.

FIG. 8 is a flowchart illustrating a procedure for file deletion according to the exemplary embodiment of the present invention.

### DETAILED DESCRIPTION OF THE EMBODIMENTS

Various exemplary embodiments, features, and aspects of the invention will be described in detail below with reference to the drawings.

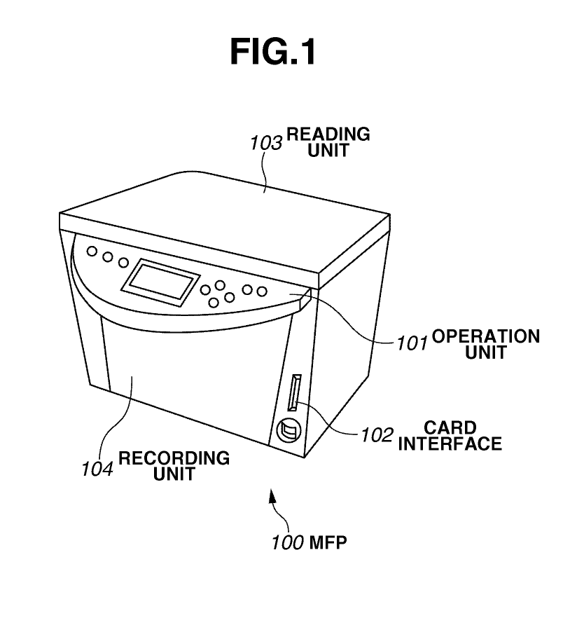

An image processing apparatus will be described as an exemplary embodiment for realizing an image file management apparatus of the present invention. FIG. 1 is an external view of a MFP 100 as the image processing apparatus according to the present exemplary embodiment. The MFP 100 has an operation unit 101, a card interface 102, a reading unit 103, and a recording unit 104. Usually, as illustrated in FIG. 1, the reading unit 103 and the recording unit 104 are in a closed state. When reading, copying, or printing from a card is executed, the reading unit 103 or recording unit 104, or both of the reading unit 103 and the recording unit 104, is/are opened, and a user executes a desired function.

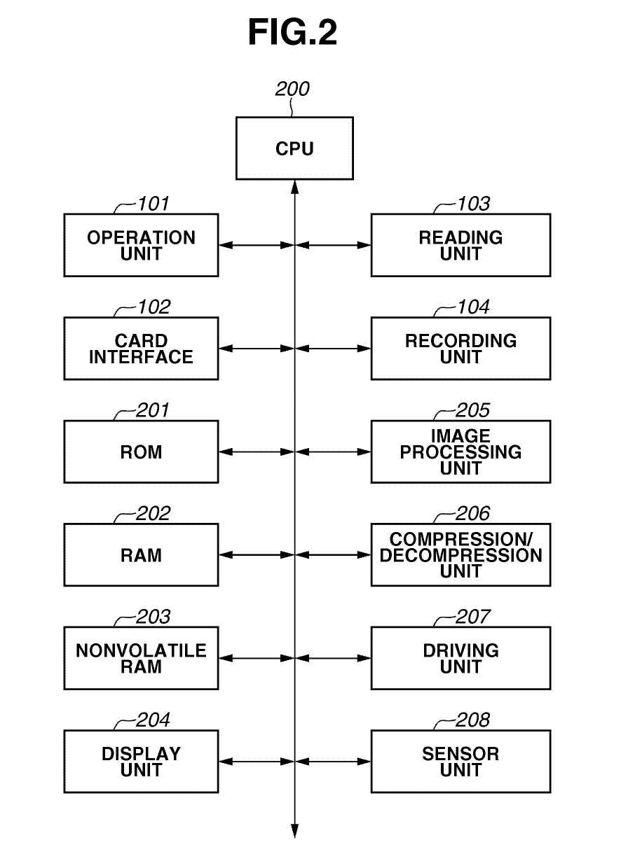

FIG. 2 is a block diagram illustrating a configuration of the MFP 100. The operation unit 101, card interface 102, reading unit 103, and recording unit 104 illustrated in FIG. 2 are the same as the operation unit 101, card interface 102, reading unit 103, and recording unit 104 described for FIG. 1. In addition to the operation unit 101, card interface 102, reading unit 103, and recording unit 104, the MFP 100 also has a central processing unit (CPU) 200, a read-only memory (ROM) 201, a random access memory (RAM) 202, a nonvolatile RAM 203, a display unit 204, an image processing unit 205, a compression/decompression unit 206, a driving unit 207, and a sensor unit 208.

The CPU 200 controls the various functions of the MFP 100. When the user performs a predetermined operation by the operation unit 101, an instruction is input to the CPU 200. Based on that instruction, the CPU 200 executes an image processing program stored in the ROM 201. The ROM 201 stores control command programs and the like of the MFP 100. The reading unit 103 includes a charge coupled device (CDD). The CCD reads an original image, and outputs analog luminance data in the colors red (R), green (G), and blue (B). The reading unit 103 may also use a contact image sensor (CIS) instead of the CCD. The card interface 102 records in a memory card or the like image data read by the reading unit 103 based on the predetermined operation of the operation unit 101. The card interface 102 may also include, for example, a function for reading image data captured by a digital still camera and recorded in the memory card based on the predetermined operation of the operation unit 101. The image data which is recorded and read via the card interface 102 may be subjected to desired image processing by the below-described image processing unit 205.

In the compression/decompression unit 206, compression/decompression of an image read by the reading unit 103 and an image output by the recording unit 104 is executed. For example, the compression/decompression unit 206 generates and decompresses compressed image in a Joint Photographic Experts Group (JPEG) method. In the image processing unit 205, input image processing of the image read by the reading unit 103 and the image decompressed by the compression/decompression unit 206 is executed. Further, in the image processing unit 205, output image processing of the image read via the card interface 102 and the image decompressed by the compression/decompression unit 206 is executed. In the input image processing and the output image processing, a conversion between a color space (e.g., YCbCr) used in a digital still camera and a standard RGB color space (e.g., National television system committee (NTSC)-RGB and standard RGB (sRGB)), and conversion of resolution of the image data are performed.

Further, the image processing unit 205 also includes functions such as image analysis and image correction, and thumbnail image generation and correction, based on generation and analysis of header information included in the image file which includes all of the image data. Image data obtained by the above described image processing is stored in the RAM 202. When such image data is recorded in the memory card via the card interface 102, once the image data reaches a required predetermined amount, a recording operation is performed. Further, when the image data is printed by the recording unit 104, once the image data reaches a required predetermined amount, a recording operation is performed by the recording unit 104.

The nonvolatile RAM 203 is a battery backed-up static random access memory (SRAM) or the like. The nonvolatile RAM 203 stores data unique to the MFP 100. The operation unit 101 has a direct photo print start key for selecting the image data stored in a storage medium and starting printing, and a scan start key for starting reading of a monochrome image and a color image. Further, the operation unit 101 has a monochrome copy start key and a color copy start key used during monochrome copying and color copying. In addition, the operation unit 101 has a mode key for designating a mode such as resolution and image quality of copying or scanning, a stop key for stopping a copy operation or the like, numerical keypads and a registration key for inputting a copy count, a cursor key for designating an image file selection unit to be printed and the like. The CPU 200 detects whether these keys are pressed or not, and controls the respective units based on the pressed state.

The recording unit 104 includes an ink jet type recording head, a general-purpose integrated circuit (IC) and the like. Based on control by the CPU 200, the recording unit 104 reads recording data stored in the RAM 202 to print and output a hard copy. The driving unit 207 includes a stepping motor for driving a paper feed and discharge roller, a gear for transmitting a driving force of the stepping motor, and a driver circuit for controlling the stepping motor, for each of the operations of the reading unit 103 and recording unit 104. The sensor unit 208 includes a recording sheet width sensor, a recording sheet presence sensor, an original document width sensor, an original document presence sensor, a recording sheet detection sensor and the like. The CPU 200 detects states of the original document and the recording sheet based on information obtained from these sensors. The display unit 204 displays contents based on the key pressed in the operation unit 101. Further, the display unit 204 also displays contents of the processing being performed by the MFP 100 and the like.

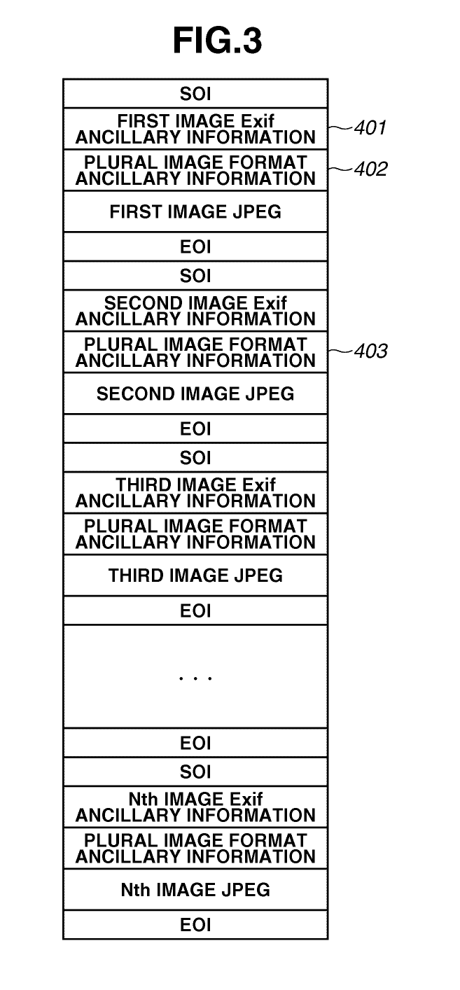

FIG. 3 illustrates a plural image format in the present exemplary embodiment. As illustrated in FIG. 3, a plural image format file in the present exemplary embodiment has n (n being an integer of 2 or more) images. In the plural image format of FIG. 3, a plurality of JPEG format images which start with a start of image (SOI) marker and end with an end of image (EOI) marker are connected. After the SOI marker on a head of the file, first image Exif ancillary information 401, first image plural image format ancillary information 402, and a first image compressed using JPEG are present. After the first image compressed using JPEG, an EOI marker is present.

After the first image EOI marker, a second image SOI marker is present, and after that second image Exif ancillary information, second image plural image format ancillary information 403, and a second image compressed using JPEG are present. Further, other information may be present between the first image EOI marker and the second image SOI marker. This configuration is similarly present from the third image until the nth image.

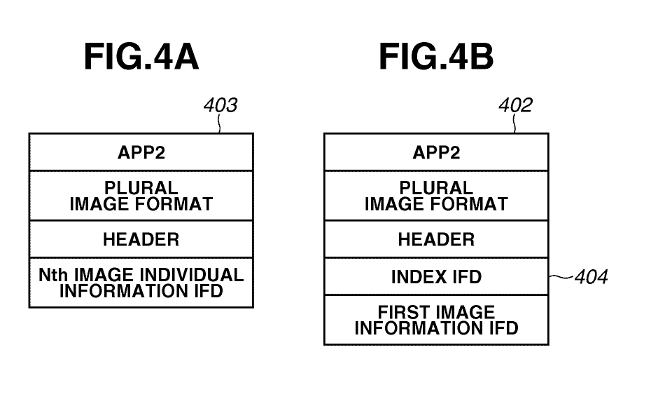

FIGS. 4A and 4B illustrate plural image format ancillary information. FIG. 4A illustrates the plural image format ancillary information 403 of the nth image (n being an integer of 2 or more) illustrated in FIG. 3. The plural image format ancillary information 403 includes an application specific (APP2) marker and an identifier which indicates the plural image format. In FIG. 4A, the identifier is indicated as “PLURAL IMAGE FORMAT”. The plural image format ancillary information 403 also includes a header, and an nth image image file directory (IFD). The nth image IFD includes information unique to the nth image. For example, such information may indicate what number image an image is in the file.

FIG. 4B illustrates plural image format ancillary information of the first image illustrated in FIG. 3. In addition to the plural image format ancillary information 403 described in FIG. 4A, plural image format ancillary information 402 of the first image includes an index IFD 404. The index IFD 404 indicates an overall configuration from the first image to the nth image.

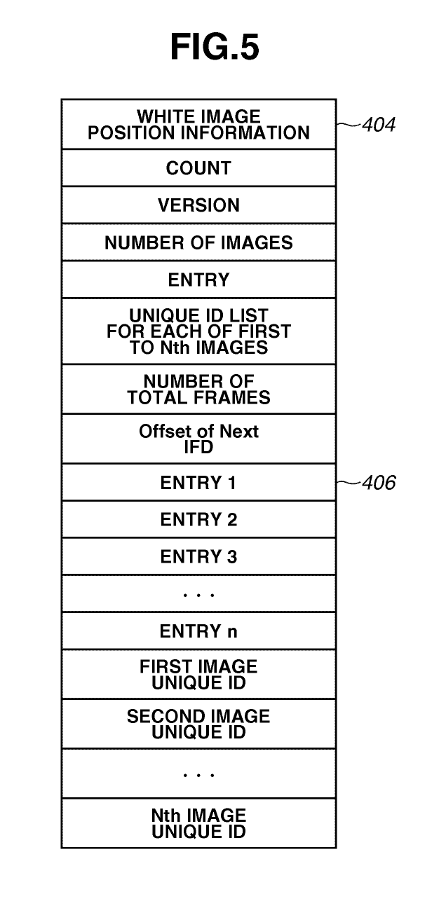

FIG. 5 illustrates an index IFD of the plural image format. The index IFD in FIG. 5 corresponds to the index IFD 404 in FIG. 4B which is included only in plural image format ancillary information 402 of the first image.

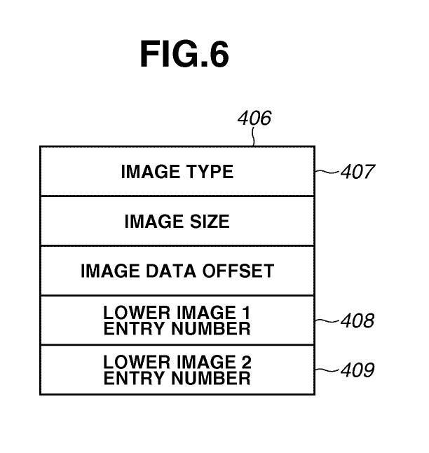

In the index IFD 404, a plural image format version, a number of images included in the file, an offset for the first image entry, a unique ID list for each of the first to nth images, a number of total frames, and an offset value for the next IFD are recorded. Further, an entry 406 for each of the first to nth images, and a unique ID for each of the first to nth images are recorded as the IFD values. The entry 406 will be described in FIG. 6. Accordingly, plural image format ancillary information of the first image and plural image format ancillary information of the second and subsequent images contain different information.

FIG. 6 illustrates an entry configuration. The entry 406 for each of the first image to nth image indicates information which is unique to each of the images. Recorded in the entry 406 are an image type 407, an image data offset which is an offset for JPEG data of each of the images, a lower image 1 entry number 408, and a lower image 2 entry number 409.

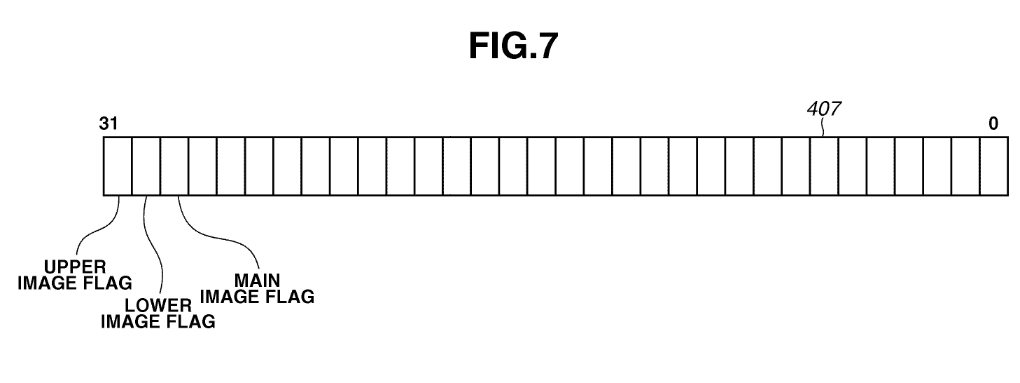

Here, a “lower image” is an image which is in a subordinate relationship to a specific image. For example, the lower image may be an image displayed on a monitor. Although such a display image has the same contents as an image in a higher position (hereinafter referred to as “upper image”), it is produced at a lower resolution. Monitor display does not require a high resolution as printing, but needs to shorten processing time to display. It is thus effective to include the display image within the file as the lower image. The lower image 1 entry number 408 and lower image 2 entry number 409 in FIG. 6 indicate what number image the lower images will become. The image type 407 will be described in FIG. 7.

FIG. 7 illustrates an internal configuration of the image type. In the image type, in addition to the above-described upper image and lower image, a main image is defined. This is because it can be thought that it is more effective if all images in the plural image format file are not in a parallel relationship. For example, during display on the monitor, although the user can select the image to be displayed from among the plurality of images included in the file, for the user, the image which is initially displayed is important. For example, when images captured while changing the white balance in several + or − stages using the bracketing photographing function are stored in a file, in order for the user to select the image, it is desirable that an image having the white balance in the standard zero position is displayed first. Thus, a leading image has to be distinguished from the other plurality of images. Therefore, the leading image is defined here as the main image.

In FIG. 7, a main image flag, a lower image flag, and an upper image flag are recorded in the image type 407. When the image is the main image, a “1” is recorded in the main image flag, and when the image is not the main image, a “0” is recorded. When the image is positioned lower than another image, a “1” is recorded in the lower image flag, and when the image is not positioned lower than another image, a “0” is recorded. When the image is positioned higher than another image, a “1” is recorded in the upper image flag, and when the image is not positioned higher than another image, a “0” is recorded.

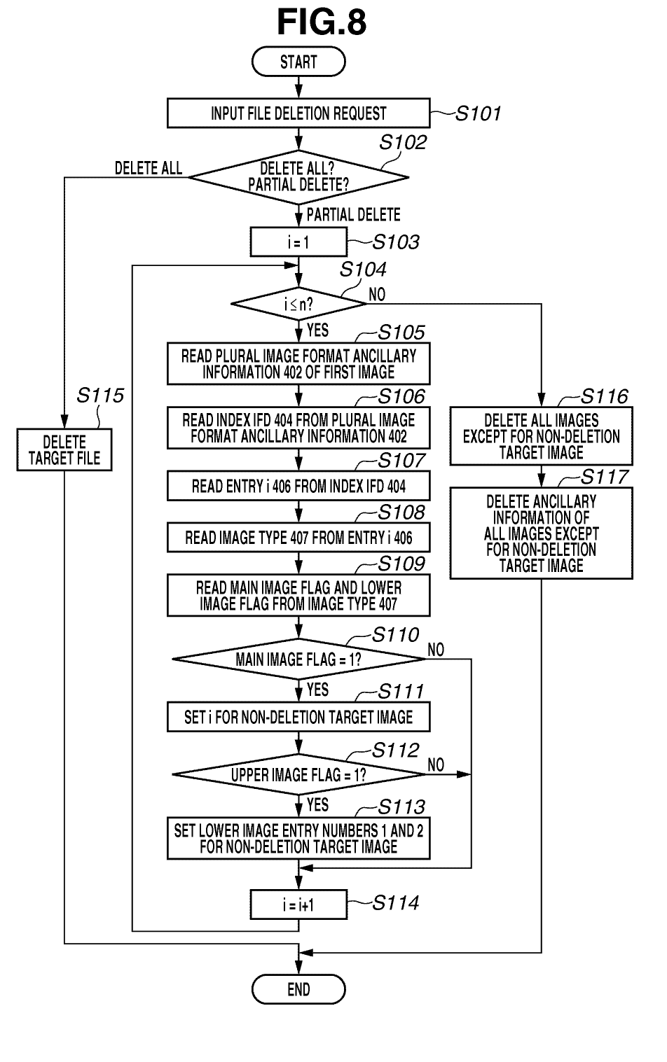

FIG. 8 is a flowchart illustrating a procedure for file deletion according to the present exemplary embodiment. Steps in the flowchart are executed by the CPU 200. When the user instructs deletion of a file by operating the operation unit 101, in step S101, a deletion request of the file is input. Generally, there are several types of deletion request. However, in the present exemplary embodiment, methods will be described in which an entire target file is deleted and in which only a deletion target image in the file and the ancillary information thereof are deleted. The latter deletion method will below be referred to as a partial deletion method.

In step S102, it is determined whether the received deletion request is a delete-all request or a partial deletion request. If it is determined that the deletion request is a delete-all request, the processing proceeds to step S115. If it is determined that the deletion request is a partial deletion request, the processing proceeds to step S103.

In step S103, the CPU 200 initializes a variable i for designating the entry number to 1. In step S104, it is determined whether the variable i designating the entry number is more than a number n of images included in the file. If it is determined that the variable i is more than the number n (NO in step S104), the processing proceeds to step S116. If it is determined that the variable i is not more than the number n (YES in step S104), the processing proceeds to step S105.

In step S105, the plural image format ancillary information 402 which is in the first image region illustrated in FIG. 3 or FIG. 4B is read.

In step S106, the index IFD 404 in the plural image format ancillary information 402 illustrated in FIG. 4B is read.

In step S107, the entry 406 of the image with entry number i (i=1, 2, . . . , n) illustrated in FIG. 5 (hereinafter referred to as entry i 406) in the index IFD 404 is read.

In step S108, the image type 407 illustrated in FIG. 6 is read from the entry i 406.

In step S109, the main image flag and lower image flag illustrated in FIG. 7 are read from the image type 407.

In step S110, it is checked whether the read main image flag is equal to 1. If the main image flag=1, deletion cannot be performed based on the partial deletion request, because the image with entry number i is the main image. Therefore, in step S111, the entry number i is recorded as a non-deletion target image.

In step S112, it is checked whether the upper image flag read in step S109 is equal to 1. If the upper image flag=1 (YES in step S112), a lower image associated with the image with the entry i 406 which is currently checked is present. Therefore, in step S113, the lower image entry number 1 and the lower image entry number 2 illustrated in FIG. 6 are set as non-deletion target images.

In FIG. 6, two entry numbers are recorded as non-deletion target images since there are two regions 1 and 2 that store lower image entry numbers. However, the number of lower images does not have to be two, and may be only one.

Further, while not illustrated, the image with the entry number i which is currently checked could be the main image and the lower image. In such a case, since there is a corresponding upper image, that upper image may be determined as an associated image of the main image and recorded as a non-deletion target image.

In step S114, the CPU 200 adds 1 to the variable i for designating the entry number, and the processing returns to step S104 for reading the next entry number i.

The above-described processing is repeated, and if the above-described operation is finished up to the final entry number, the process proceeds from step S104 to step S116. As a result, all images other than the non-deletion target images are deleted. In step S117, the ancillary information of all images other than the non-deletion target images is further deleted.

According to the above-described processing, a main image is extracted from a plural image format file, and the extracted main image and an upper image or a lower image related to the main image can be excluded from deletion targets. As a result, a user can easily delete non-required images by a single deletion instruction. Especially in the plural image format file described in the present exemplary embodiment, a main image is indicated by plural image format ancillary information which is ancillary information of the first image among the plurality of images. Therefore, only a region which is relatively near a head of the file needs to be analyzed to designate a non-deletion target image. More specifically, the present exemplary embodiment can determine whether the image is a deletion target by analyzing the head region of the file and delete images based on an offset value of the deletion target image, so that high-speed processing can be performed.

Further, a positional relationship between a remaining main image and a lower image which are not deleted may be maintained so that the main image is at the head of a file and after the main image the lower image is placed, while this positional relationship may be reversed. Alternatively, whether to place the main image or the lower image at the head of the file may be selected via a user interface. When a plurality of main images and lower images are present, the positional relationship in the file before deletion may be maintained, or which image is to be placed at the head of the file may be selected via the user interface.

In addition, as a result of deleting all of the deletion target images and ancillary information, an extension forming a file name may also be changed. For example, when there is one JPEG image which is not deleted, the extension may be changed to “.jpg”, “.jpeg” or the like. The extension may also be changed if there is a plurality of images which are not deleted.

While the above exemplary embodiment is described with an MFP used as an example of the apparatus on which image deletion is performed, the present invention is not limited to the MFP. For example, image deletion may be performed by a computer such as a PC, or by a digital camera.

Further, the present invention can be achieved by supplying a recording medium on which a program code for realizing the functions of the above exemplary embodiments is recorded to a system or an apparatus, and causing a computer (or a CPU or a micro processing unit (MPU)) of the system or apparatus to read and execute the program code. In this case, the program code read from the recording medium realizes the functions of the above exemplary embodiments, so that the recording medium on which that program code is recorded, and that program code itself, constitute the present invention.

The present invention can be also achieved when an operating system (OS) running on the computer performs a part or all of the actual processing based on an instruction from the program code which is supplied by the recording medium, and realizes the functions of the above-described exemplary embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-196407 filed Jul. 30, 2008, which is hereby incorporated by reference herein in its entirety.

What is claimed is:

1. A method for managing an image file in which a plurality of images each having ancillary information is sequentially included, and in which a main image among the plurality of images is indicated based on the ancillary information of the image stored at a head of the image file, the method comprising:
inputting an instruction to delete an image included in the image file; and
based on the input of the instruction, deleting images other than at least the main image from among the plurality of images included in the image file based on the ancillary information of the image stored at the head of the image file.

2. The method according to claim 1, wherein the ancillary information of the image stored at the head of the image file indicates an upper image or a lower image with respect to the main image, and when images are deleted, images other than the main image, its upper images and/or lower images are deleted from among the plurality of images based on the ancillary information of the image stored at the head of the image file.

3. The method according to claim 1, wherein when images other than the main image are deleted from among the plurality of images included in the image file during image deletion, an extension of the image file is changed.

4. The method according to claim 3, wherein the images included in the image file are JPEG format images, and when images other than the main image are deleted from among the plurality of images included in the image file during image deletion, the extension of the image file is changed to an extension compatible with the JPEG format.

5. The method according to claim 1, wherein the images included in the image file are JPEG format images, and have Exif ancillary information.

6. A computer-readable recording medium recording a program which executes the method according to claim 1 on a computer.

7. A file management apparatus that manages an image file in which a plurality of images each having ancillary information is sequentially included, and in which a main image among the plurality of images is indicated based on the ancillary information of the image stored at a head of the image file, the file management apparatus comprising:
an input unit configured to input an instruction to delete an image included in the image file; and
a deletion unit configured to, based on the instruction for input by the input unit, delete images other than at least the main image from among the plurality of images included in the image file based on the ancillary information of the image stored at the head of the image file.
